(19) United States
(12) Patent Application Publication
(10) Pub. No.: US 2025/0284082 A1
(43) Pub. Date: Sep. 11, 2025

(54) FIBER OPTIC CABLE MANAGEMENT SYSTEMS AND METHODS

(71) Applicant: COMMSCOPE TECHNOLOGIES LLC, Claremont, NC (US)

(72) Inventors: Thierry Mike DECLERCK, Kumtich (BE); Debora DOCKX, Duffel (BE)

(73) Assignee: COMMSCOPE TECHNOLOGIES LLC, Claremont, NC (US)

(21) Appl. No.: 19/215,014

(22) Filed: May 21, 2025

Related U.S. Application Data
(63) Continuation of application No. 17/916,419, filed on Sep. 30, 2022, now Pat. No. 12,339,511.
(60) Provisional application No. 63/003,043, filed on Mar. 31, 2020.

(51) Int. Cl. G02B 6/44

(52) U.S. Cl. CPC G02B 6/44515; G02B 6/4447; G02B 6/44528; G02B 6/44524

(57) ABSTRACT

A fiber management cable assembly for facilitating routing and storing optical fibers includes a plurality of fiber fixation tabs. The plurality of fiber fixation tabs can provide fixation for optical fibers supported by, mounted on, or attached to components within a telecommunications enclosure. The plurality of fiber fixation tabs can secure optical fibers that are in a multi-fiber (e.g., ribbon) configuration or a single fiber configuration.

### CROSS-REFERENCE TO RELATED APPLICATION

This application is a Continuation of U.S. patent application Ser. No. 17/916,419, filed on Sep. 30, 2022; which is a National Stage Application of PCT/US2021/025135, filed on Mar. 31, 2021; which claims the benefit of U.S. Patent Application Ser. No. 63/003,043, filed on Mar. 31, 2020, the disclosures of which are incorporated herein by reference in their entireties. To the extent appropriate, a claim of priority is made to each of the above disclosed applications.

### TECHNICAL FIELD

The present disclosure relates generally to telecommunications cable management devices. More specifically, the present disclosure relates to fiber optic cable management systems and methods.

### BACKGROUND

Various devices are used to manage, store and/or protect optical fibers and optical splices. These devices may include trays that have relatively hard plastic constructions and include added structures for routing optical fibers and splicing locations. Improvements in fiber management are needed for optical fiber accessibility, handling, managing, and storing.

### SUMMARY

Certain aspects of the present disclosure relate to a fiber optic management assembly or system for managing optical fibers, such as in fiber optic equipment, such as closures.

The fiber optic management system can include a telecommunications equipment, such as a closure, including a base; a cover; at least one mounting structure positioned within the base of the telecommunications equipment; at least one fixation element; and at least one optical fiber mounted to the at least one fixation element. The fixation element mounts to the mounting structure to mount the optical fiber to the base of the telecommunications equipment.

In certain examples, the at least one fixation element can take the form of a fixation tag mounted to the optical fiber. The fixation tag can mount to the at least one mounting structure to manage the at least one optical fiber within the telecommunications equipment. The fixation tag can take the form of a flexible foil mounted to at least part of the optical fiber.

In some embodiments, there is more than one optical fiber mounted to the fixation tag.

In some embodiments, there is more than one fixation tag for the optical fiber or fibers.

In some embodiments, the mounting structure includes a post for receiving the fixation tag.

In some embodiments, the mounting posts can include retention portions, such as a shoulder or an enlarged portion to increase retention of the fixation tag.

In some embodiments, the post is one post and a plurality of other posts are provided for additional fixation tags.

In some examples, the flexible foil is used for manufacturing the fiber optic circuit with the various fiber optic cables of the circuit. In some cases, the fiber optic circuit can include loose fibers, ribbonized fibers, or fibers contained within a flex foil.

The fixation element or elements hold the optical fiber or fibers in a desired location within the closure or other device so that the fiber or fibers are not damaged or excessively bent.

Another aspect of the present disclosure relates to a fiber management cable assembly where the optical fiber circuit extends from one end to an opposite end. The ends can be spliced to other fibers or connectorized with single fiber connector(s) or multifiber connector(s). The fiber management cable assembly can include at least one flexible foil element, and optical fibers mounted to the one or more flexible foil elements.

In certain examples, the fiber management cable assembly can include a plurality of flexible foil elements. The plurality of flexible foil elements can include at least one management feature for managing optical fibers attached thereto within a telecommunications equipment.

Another aspect of the present disclosure relates to a method of assembly. The method can include a step of providing a fiber management cable assembly. The fiber management cable assembly can include one or a plurality of fixation elements. The method can also include one or a plurality of optical fibers mounted to the one or the plurality of fixation elements. The method can further include a step of mounting the one or the plurality of fixation elements to one or more mounting structures located within telecommunications equipment.

A further aspect of the present disclosure relates to a telecommunications equipment. In certain examples, the telecommunications equipment can include a housing including a base and a plurality of fiber optic adapters secured to the housing. The fiber optic adapters can include connector ports accessible from inside the housing.

In certain examples, the telecommunications equipment can include a plurality of mounting structures positioned within the base and a plurality of fixation tabs. The plurality of fixation tabs can include a foil.

In certain examples, the telecommunications equipment can include a plurality of optical fibers mounted to the plurality of fixation tabs. The plurality of fixation tabs can be mountable to the plurality of mounting structures to manage the optical fibers within the housing.

In certain examples, the optical fibers can have connectorized ends that plug into the connector ports of the fiber optic adapters.

The various aspects characterized above in this section can be used together or separately in enclosure arrangements.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic view showing multiple layers of an example fiber management cable assembly in accordance with principles of the present disclosure.

FIG. 2 is top, plan view of a fiber management cable assembly depicting an example flexible fiber circuit.

FIG. 3 is a schematic view of a fiber management cable assembly including a fixation element and optical fibers mounted to the fixation element in accordance with the principles of the present disclosure.

FIG. 4 is a schematic view of examples of multiple fixation elements defining a cutout region in a variety of shapes in accordance with the principles of the present disclosure.

FIGS. 5-6 are perspective views of the fixation element of FIG. 3 positioned in a telecommunications equipment in accordance with the principles of the present disclosure.

FIGS. 7A-C show examples of some top profiles for the mounting posts of the equipment.

FIGS. 8A-C show examples of some side profiles for the mounting posts of the equipment.

FIGS. 9-12 show various telecommunications equipment with fixation elements for mounting optical fibers in the equipment.

### DETAILED DESCRIPTION

The present disclosure is directed generally to a fiber optic management system that includes fiber fixation elements, for example film elements, or flexible foil elements. In certain examples, the fixation elements of the present disclosure can be arranged and configured for use within a telecommunications equipment. The fixation elements can be utilized to position optical fibers within the telecommunications equipment.

In certain examples, the optical fibers can be terminated by a fiber optic connector or fiber optic connectors. Non-limiting examples of connectors include MPO style connectors, and single or duplex fiber connectors, such as LC or SC type connectors.

The fixation elements can include one or more (typically, multiple) optical fibers attached to and supported by a flexible planar substrate, such as a Mylar™ or other flexible polymer substrate. Although specific examples herein depict and describe planar substrates, it should be appreciated that other substrate configurations, e.g., in which a substrate fix optical fibers in and/or across multiple planes are also contemplated. In certain examples, the optical fibers can extend past ends of the film elements so that they can be terminated to optical connectors, which can be coupled to fiber optic cables or other fiber optic components through mating optical connectors.

The film elements can be constructed from preformed fiber optic circuits. Example fiber optic circuits is disclosed in PCT International Patent Application No. PCT/US2018/053935 (WO2019/070682A2), the disclosure of which is incorporated herein by reference in its entirety.

The fixation elements allow for quicker installation of the optical fibers into a telecommunications device such a closure. In one example, retention posts in the equipment interact with fixation tags of the optical circuit allow for rapid assembly of the optical circuit to the equipment.

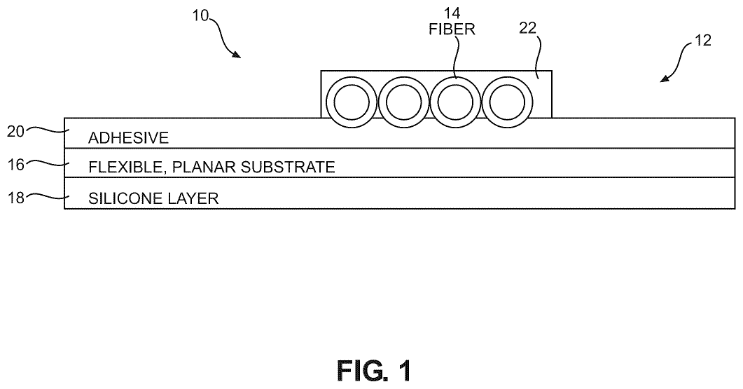

Turning to FIG. 1, a schematic view of a fiber management cable assembly 10 is illustrated. The fiber management cable assembly can include an example film element 12 (e.g., a flexible foil element; a fiber fixation tab, a fiber fixation tag, a PET foil) and one or more optical fibers 14. The film element 12 can include a composite structure that includes at least three layers of which one layer is a flexible planar substrate 16, a silicone coating layer 18, and an adhesive layer 20. That is, the flexible planar substrate 16 may have a siliconized side to facilitate release and an opposite, adhesive side.

Example adhesives include epoxy, light curable adhesive (e.g., ultraviolet light curable adhesive), thermo-form adhesive, thermo-set adhesive, index-matching adhesive or other adhesives. In certain examples, the adhesive layer 20 can be deposited on top of the flexible planar substrate 16.

In certain examples, the film element can be a multi-layer substrate that can include: a first planar flexible substrate layer (e.g., base substrate layer, bottom substrate layer, bulk substrate), an adhesive layer (e.g., epoxy), and an optional second planar flexible substrate layer (e.g., top substrate layer), although alternatives are possible.

In certain examples, the flexible planar substrate 16 may be formed from polyethylene terephthalate (PET). However, it would be understood that PET is simply one non-limiting example polymer that may be used to form the flexible planar substrate 16 of the present disclosure, and other polymers having similar characteristics can be used in accordance with the principles of the present disclosure, such as Mylar™.

The adhesive layer 20 on the flexible planar substrate 16 may be adapted to support the optical fibers 14. That is, one or more optical fibers 14 can be routed on the flexible planar substrate 16, typically with a needle extending from a robotic arm, and then secured to the flexible planar substrate 16 with the adhesive layer 20, which is allowed to set or cure.

In certain examples, an additional optional layer of material 22 can be applied on top of the optical fibers 14 and the adhesive layer 20 to affix the optical fibers 14. Any suitable material can be used for this purpose. In one non-limiting example, an elastomer such a silicone coating can be applied on top of the optical fibers 14 and the adhesive layer 20. The silicone coating layer 18 may be used to supplement the adhesive layer 20 to fix the optical fibers 14 onto the flexible planar substrate 16 and to cover the adhesive layer 20 to limit tackiness.

The film element 12 described above is one example of a fixation element for the optical fiber or fibers to be used with telecommunications equipment.

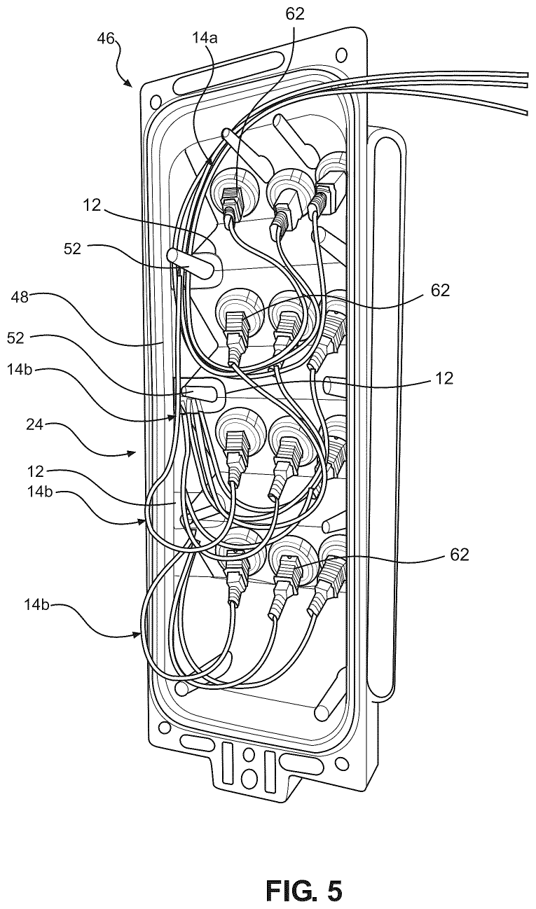

The method of assembly of the fiber management cable assembly 10 provides a number of advantages. For example, the assembly of the fiber management cable assembly 10 in accordance with the principles of the present disclosure allows a designer or technician to fix the optical fibers 14 in a predictable and automated manner such that a desired orientation or layout of the optical fibers 14 can be achieved. The film elements 12 are preferably constructed with a foil adapted to fix the optical fibers 14 within a telecommunications equipment 24 (see FIG. 5) that optimizes fiber bend radius limits and requirements. In certain examples, the telecommunications equipment 24 can be a closure, a module, a panel, or a tray, although alternatives are possible.

Aspects of the present disclosure relate to the flexible film-like substrate optionally having a flexibility that flexes up to but not beyond a minimum bend radius of an optical fiber intended to be managed. In one example, the optical fiber is a G657A or G652D optical fiber.

In one example, a plurality of different types of optical fibers are intended to be fixed by the film elements, and the minimum bend radius beyond which the film elements do not flex corresponds to the minimum bend radius of the optical fiber having the highest minimum bend radius of the optical fibers.

Preferably, the film elements 12 do not break or kink to ensure the safety and protection of the optical fibers 14. In certain examples, the film elements 12 are bendable in such a way that the optical fiber bend radius requirements are respected and satisfied.

In other examples, the film elements 12 may have a flexibility that allows the film elements to flex along a bend smaller than a minimum bend radius of the optical fiber or fibers being managed.

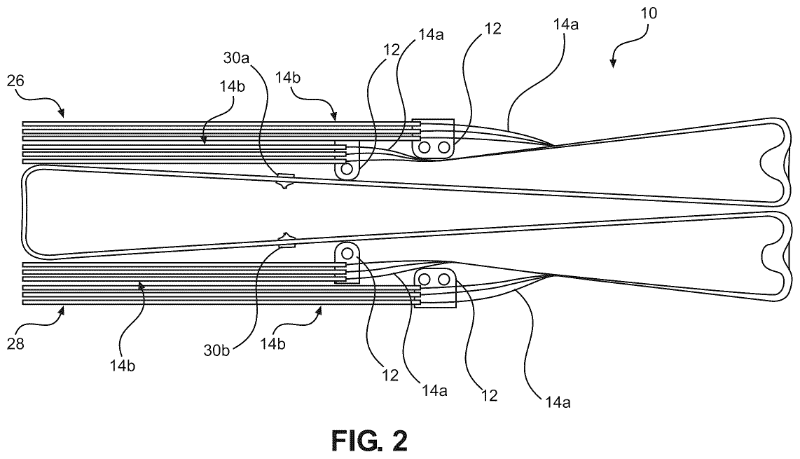

Turning to FIG. 2, a schematic top view of the example fiber management cable assembly 10 (e.g., final product cut from bulk substrate) including an example flexible fiber circuit is illustrated in accordance with the principles of the present disclosure.

Various optical fibers 14 are shown organized and supported by a plurality of film elements 12. In certain examples, the fiber management cable assembly 10 can include loose fibers 14a or single stranded fibers that are not coated. The loose fibers 14a can be left as a bare fiber. In other areas, the fiber management cable assembly 10 can include ribbonized fibers 14b. The ribbonized fibers 14b can be coated fibers.

The fiber management cable assembly 10 can include a first fiber optic circuit 26 and a second fiber optic circuit 28 that each include ribbonized fibers 14b. An example method of preparation of the first and second fiber optic circuits 26, 28 is disclosed in PCT International Patent Application No. PCT/US2018/053935 (WO2019/070682A2), the disclosure of which is incorporated herein by reference in its entirety.

That is, the first fiber optic circuit 26 can include six sets of twelve fibers that can be connectorized with a multi-fiber connector (not shown). That is, ends of the optical fibers 14b can be cleaved and polished in preparation of being terminated to a multi-fiber connector.

In certain examples, the loose fibers 14a or the ribbonized fibers 14b may be connected to other ribbons or connector (multi-fiber/simplex) stub fibers via a splicing operation. The second fiber optic circuit 28 may also include six sets of twelve fibers that may be connectorized later or later spliced.

In certain examples, identification flags 30a, 30b can be provided on the fiber management cable assembly 10 as a marker for correctly orienting and identifying the optical fibers 14b from one end of a piece of telecommunications equipment to an opposite end.

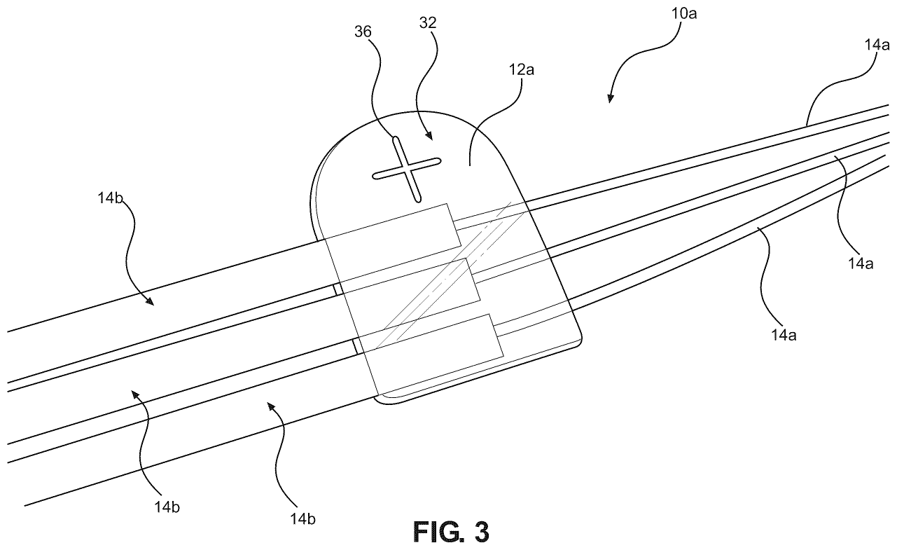

Turning to FIG. 3, a schematic view of another example fiber management cable assembly 10a is depicted. The fiber management cable assembly 10a can include a film element 12a and three sets of twelve ribbonized fibers 14b and loose fibers 14a mounted to the film element 12a. In the example depicted, the film element 12a defines a cutout region 32 that has a shape or configuration of a plus-sign, although alternative shapes are possible. The cutout region 32 of the film element 12 can be cut out into multiple shapes and/or sizes. For example, the cutout region 32 of the film element 12 can be cut or torn out as indicated at a perforated line 34 (e.g., cutting line, scored line). The cutting process can be accomplished by any known cutting techniques. For example, any known arrangements, operations, controlling machines or devices for cutting-out, stamping out, punching, perforating and also for severing may be used.

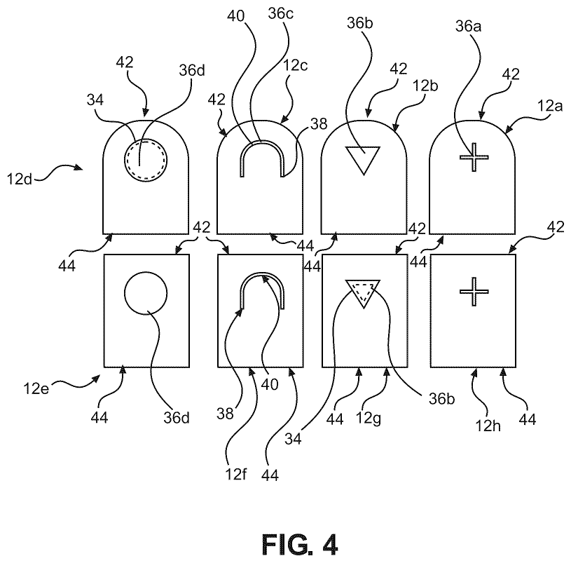

Referring to FIG. 4, multiple film elements 12a-h are depicted. The film elements 12a-h can each include the cutout region 32. In certain examples, the film elements 12a-h may each include the perforated line 34 (e.g., cutting line, scored line) about the cutout region 32. Tearing along the perforated line 34 of the cutout region 32 allows a portion of the material of the film element 12 to be removed to create an opening 36 (e.g., fixation holes, apertures) therein.

In certain examples, the film element 12 may include a plus-sign opening 36a, a triangular opening 36b, a U-shaped opening 36c or a circular opening 36d. It will be appreciated that any number of shapes are possible. The cutout region 32 of the film elements 12a-h can be used to frictionally mount the film elements 12a-h to structure positioned within the telecommunications equipment 24. In certain examples, the U-shaped opening 36c can be fixed at one end 38 and unattached at the other end 40 to create a flap that may be flexed up to allow the U-shaped opening 36c to receive structure on the telecommunications equipment 24. In addition, structure located within the telecommunications equipment 24 can be received within the triangular, circular, or plus-sign openings 36a,b,d to frictionally mount the film elements 12a-h thereto.

The film elements 12 can take the shape of a square, rectangle, or circle, although alternatives are possible. In certain examples, the film elements 12a-d can have a curved edge at a first end 42 and a substantially straight edge at an opposite, second end 44, although alternatives are possible. In certain examples, the film elements 12e-h may have two substantially straight edges at the first and second ends 42, 44.

Referring to FIG. 5, an example fiber optic management system 46 is depicted in accordance with the principles of the present disclosure.

The fiber optic management system 46 can include the telecommunications equipment 24 having a base 48, at least one mounting structure 50 positioned within the base 48 of the telecommunications equipment 24, at least one film element 12, and at least one optical fiber 14 mounted to the at least one film element 12.

In certain examples, the at least one mounting structure 50 includes a plurality of mounting structures, the at least one film element 12 includes a plurality of film elements, and the at least one optical fiber 14 includes a plurality of optical fibers 14.

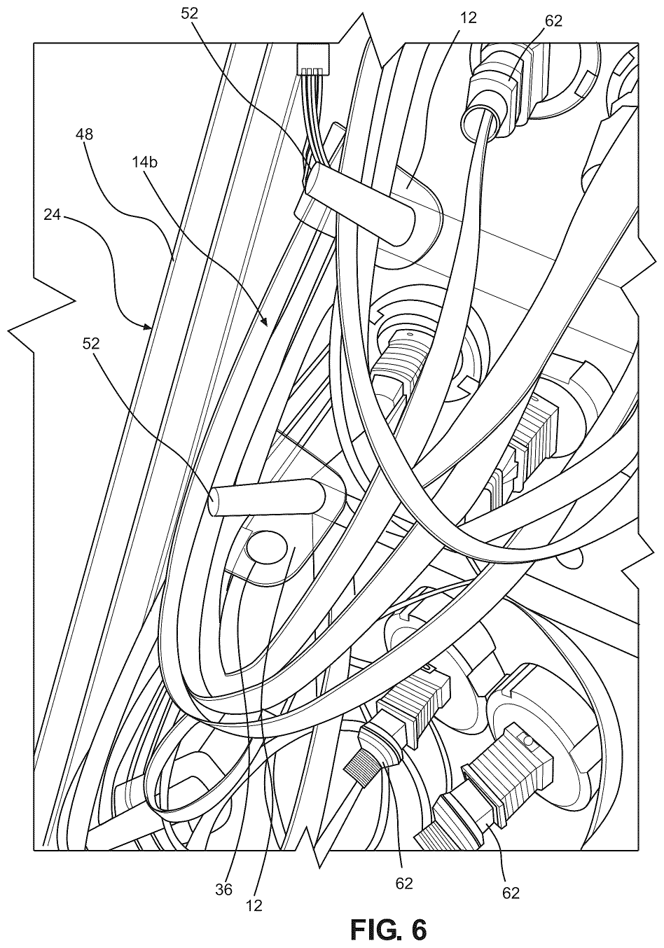

Turning to FIG. 6, the at least one film element 12 can be removably and frictionally mounted to the at least one mounting structure to manage the at least one optical fiber 14 within the telecommunications equipment 24. In certain examples, the at least one mounting structure 50 includes at least one post 52 (e.g., support, catch) located within the telecommunications equipment 24. The post 52 can be arranged and configured to be received in the opening 36 of the film element 12. That is, the opening 36 defined in the at least one film element 12 can be adapted to receive the at least one mounting structure 50 such that the at least one film element 12 and the at least one optical fiber 14 can be attached or mounted in the base 48 of the telecommunications equipment 24. For example, when the film element 12 is mated with the mounting structure 50, the mounting structure 50 is inserted through the opening 36 defined in the film element 12 to fix or hold the optical fiber 14 in a fiber optic module, in a fiber optic housing, to a fiber optic panel, to a fiber optic frame, to a fiber optic tray or elsewhere. In certain examples, multiple film elements 12 may be mounted to a single mounting structure 50.

The fiber management cable assembly 10 including the film elements 12 and the optical fibers 14 can be arranged and configured such that the optical fibers 14 can be positioned in a pre-determined and fixed routing path within the telecommunications equipment 24. The film elements 12 can be used as a fiber management or routing tab such that separate retainers, lips, or fingers are not needed to fix or manage the optical fibers 14 within the telecommunications equipment 24.

In certain examples, the film elements 12 can be used for constraining lengths of optical fibers 14 loosely arranged on the telecommunication equipment 24. That is, the film elements 12 can be used to manage optical fibers 14 that are not adhesively attached.

Another aspect of the present disclosure relates to a method of assembly. The method can include a step of providing the fiber management cable assembly 40 that has a plurality of film elements 12. The method can also include a step of mounting a plurality of optical fibers 14 to the plurality of film elements 12. The method can further include a step of frictionally fixing the plurality of film elements 12 to selectively mounted structures 50 located within the telecommunications equipment 24. In certain examples, the method can include a step of cutting the plurality of film elements 12 to define the openings 36 therein. In certain examples, the method can include a step of connectorizing the plurality of optical fibers 14.

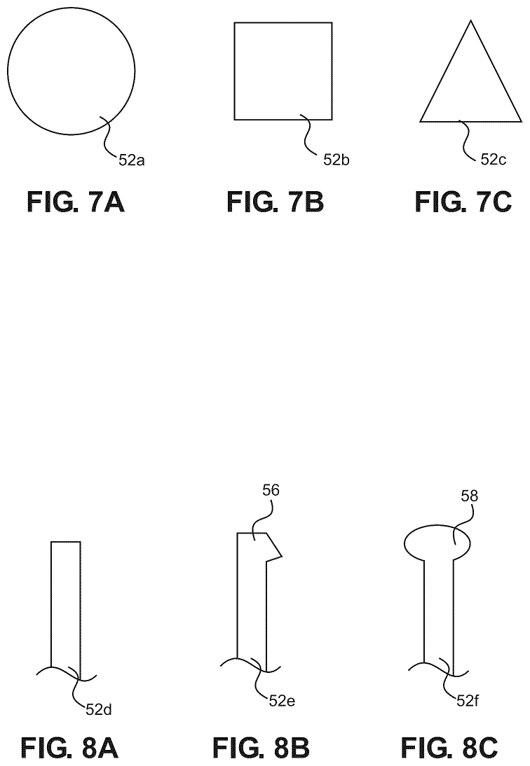

Referring now to FIGS. 7A-C, various example shapes for the posts 52 are shown. Post 52a is generally cylindrical. Post 52b is generally square. Post 52c is generally triangular.

FIGS. 8A-C shows various examples of the posts 52 from a side view. FIG. 8A shows a cylindrical post 52d. FIG. 8B shows a post 52e with a retention flange 56 to improve the retention of the film element 12. FIG. 8C shows an enlarged tip 58 to improve the retention of the film element 12.

With the optical circuit managed by the fixation tags 12 (for example film tags), the fibers are mounted to the equipment in an easier operation than feeding loose fibers under overhanging tabs.

With the optical circuit managed by the fixation tags 12 (for example film tags), the fibers are mounted to the equipment for longer term retention than feeding loose fibers under overhanging tabs. In other words, the fibers are less likely to pop out and get caught in an interface between a cover and a base or in a hinge area.

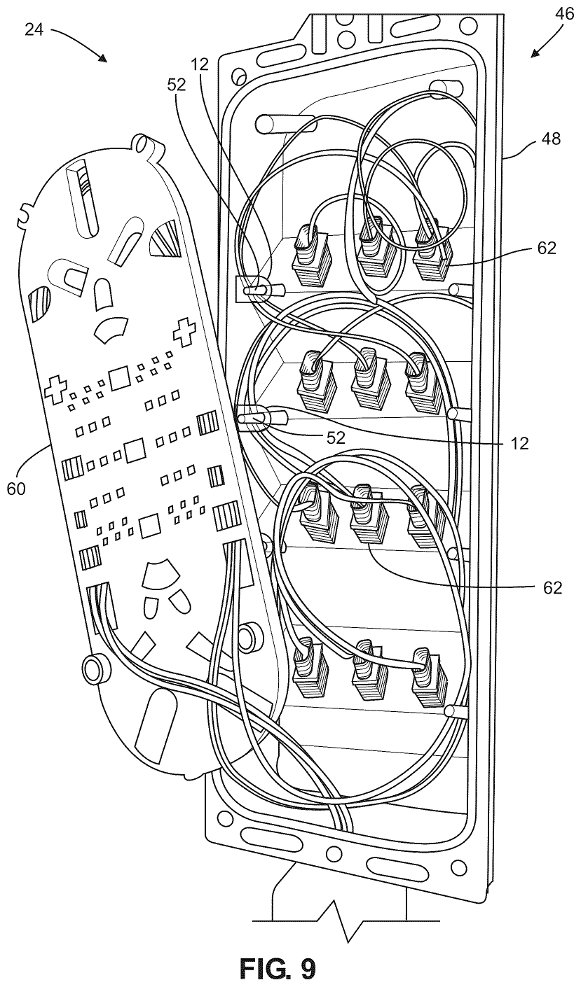

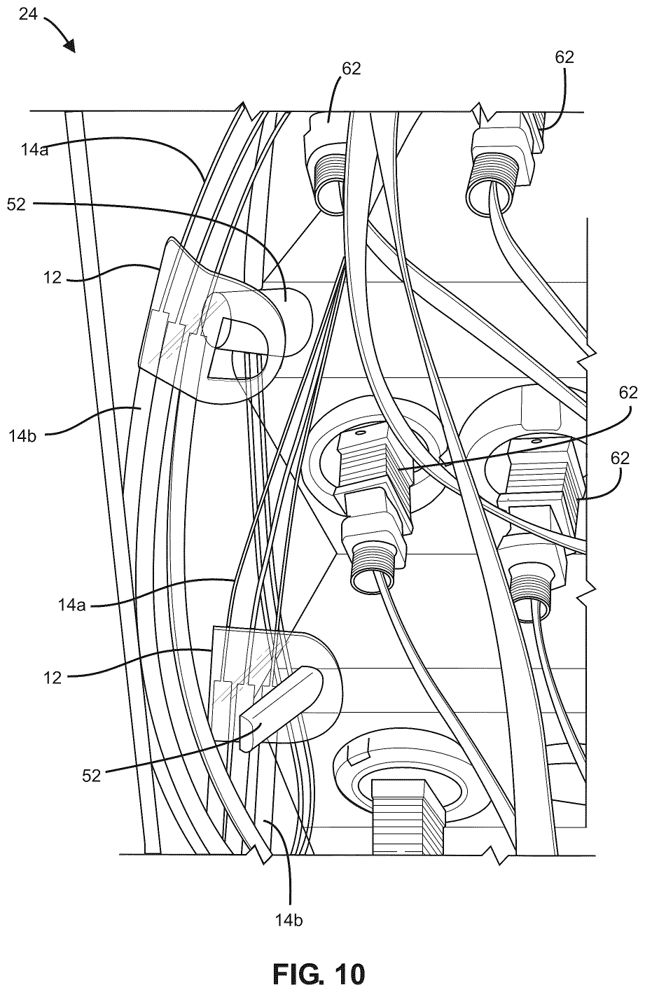

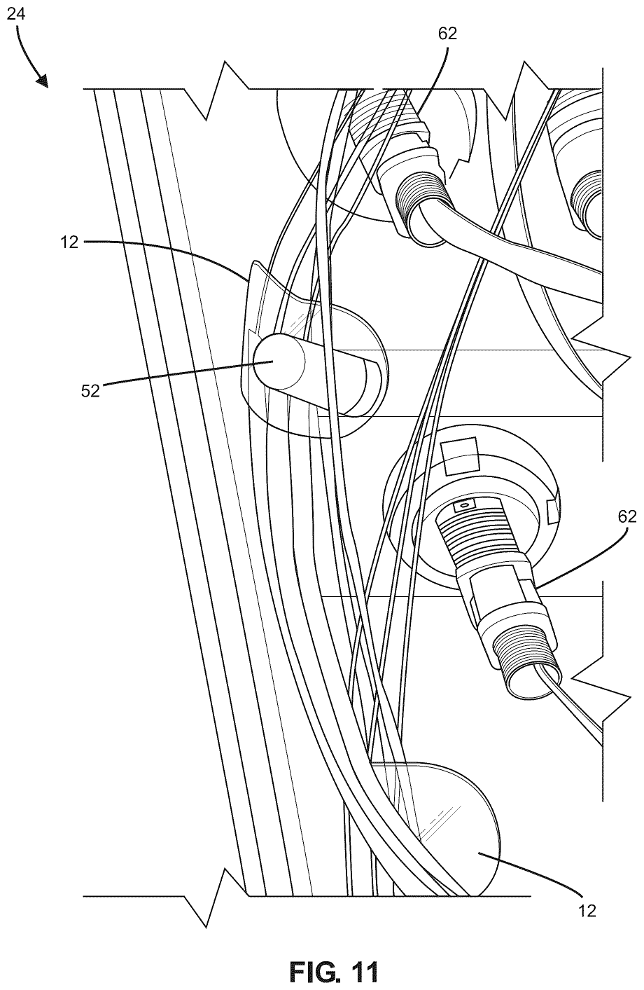

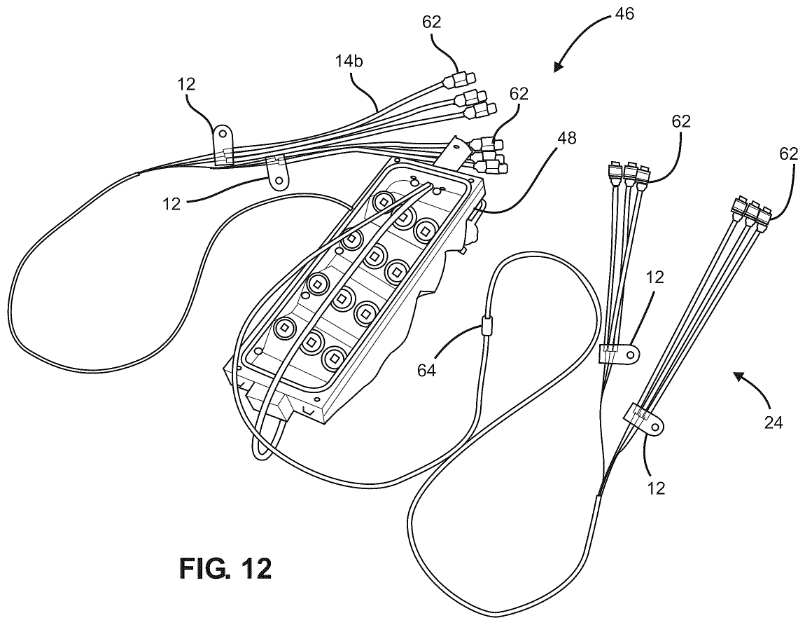

Referring to FIGS. 9-12, various examples of equipment 24 are shown where film elements 12 are used to secure fibers to a base 48 for example. FIG. 9 shows a fiber management tray 60 for use in managing the fibers in the equipment, including fiber slack. FIGS. 9-12 show MPO connectors 62 mounted on the ends of ribbon cables. FIG. 12 shows a splice 64 for connecting the fibers of the fiber assemblies 10 to one another. The splice 64 can be secured on a tray like tray 60.

From the forgoing detailed description, it will be evident that modifications and variations can be made without departing from the spirit and scope of the disclosure.

1. A fiber optic management system, comprising:
a telecommunications equipment including a base;
at least one optical fiber managed within the base of the telecommunications equipment;
at least one tab that includes a planar flexible substrate layer and a coating layer on the planar flexible substrate layer; and
the at least one optical fiber mounted to the at least one tab;
wherein the fiber optic management system further includes an identification flag in addition to the at least one tab provided on the at least one optical fiber for correctly identifying and orienting the at least one fiber from one end of the telecommunications equipment to an opposite end of the telecommunications equipment.

2. The fiber optic management system of claim 1, wherein the fiber optic management system includes at least one mounting structure positioned within the base of the telecommunications equipment and at least one fixation element that is defined by the at least one tab, wherein the at least one fixation element includes a perforated line at a cutout region that is adapted to be torn to define an opening for receiving the at least one mounting structure of the telecommunications equipment.

3. The fiber optic management system of claim 2, wherein the at least one mounting structure is a post located within the telecommunications equipment.

4. The fiber optic management system of claim 1, wherein the at least one optical fiber includes a plurality of ribbonized optical fibers that are mounted to the at least one tab.

5. The fiber optic management system of claim 4, wherein the plurality of ribbonized optical fibers includes a first set of ribbonized optical fibers and a second set of separate ribbonized optical fibers, wherein at least one of the first set of ribbonized optical fibers and the second set of ribbonized optical fibers are mounted to the at least one tab.

6. The fiber optic management system of claim 1, wherein the planar flexible substrate layer is a first planar flexible substrate layer, the tab further includes a second planar flexible substrate layer, and the coating layer is located between the first and second planar flexible substrate layers.

7. The fiber optic management system of claim 1, wherein the at least one tab includes a foil.

8. The fiber optic management system of claim 1, wherein the at least one optical fiber is terminated by a fiber optic connector.

9. A fiber management cable assembly, comprising:
flexible foil elements; and
optical fibers mounted to the flexible foil elements, wherein the fiber management cable assembly includes identification flags provided on the optical fibers for correctly identifying and orienting the optical fibers.

10. The fiber management cable assembly of claim 9, wherein the flexible foil elements each define a cutout.

11. The fiber management cable assembly of claim 9, wherein the optical fibers are terminated by fiber optic connectors.

12. The fiber management cable assembly of claim 9, wherein the flexible foil elements are fiber fixation tabs.

13. The fiber management cable assembly of claim 12, wherein each one of the fiber fixation tabs includes a planar flexible substrate layer and a coating layer on the planar flexible substrate layer.

14. The fiber management cable assembly of claim 12, wherein each one of the fiber fixation tabs includes a first planar flexible substrate layer, a second planar flexible substrate layer, and a coating layer located between the first and second planar flexible substrate layers.

15. A method of assembly comprising:
providing a fiber management cable assembly, the fiber management cable assembly including a plurality of film elements;
mounting a plurality of optical fibers to the plurality of film elements; and
placing the plurality of film elements within a telecommunications equipment; and
providing identification flags on the plurality of optical fibers for correctly identifying and orienting the optical fibers within the telecommunications equipment.

16. The method of claim 15, further comprising a step of cutting the plurality of film elements to define an opening therein and frictionally fixing the plurality of film elements to selective mounting structures within the telecommunications equipment via the openings.

17. The method of claim 16, wherein the mounting structures include posts.

18. The method of claim 17, wherein the posts are received in the opening of the plurality of film elements when the plurality of film elements are frictionally fixed to the mounting structures.

19. The method of claim 15, wherein the plurality of film elements define tabs that include a planar flexible substrate layer and a coating layer on the planar flexible substrate layer.

20. The method of claim 15, further comprising a step of connectorizing the plurality of optical fibers.

21-29. (canceled)

30. A telecommunications equipment comprising:
a housing including a base;
a plurality of fiber optic adapters secured to the housing, the plurality of fiber optic adapters including connector ports accessible from inside the housing;
a plurality of tabs, the plurality of tabs including a foil; and
a plurality of optical fibers mounted to the plurality of tabs,
wherein the optical fibers have connectorized ends that plug into the connector ports of the fiber optic adapters,
wherein the telecommunications equipment further includes identification flags provided on the plurality of optical fibers for correctly identifying and orienting the optical fibers from one end of the housing to an opposite end of the housing.

31. The fiber management cable assembly of claim 9, wherein the identification flags are separate from the flexible foil elements.

32. The method of claim 15, wherein the identification flags are provided on the plurality of optical fibers separately from the plurality of film elements.

33. The telecommunications equipment of claim 30, wherein the identification flags are separate from and in addition to the plurality of tabs.
